(19) United States
(12) Patent Application Publication
(10) Pub. No.: US 2010/0014946 A1
(43) Pub. Date: Jan. 21, 2010

(54) CATALYST FLOW CONTROL DEVICE FOR TRANSFER OF SOLIDS BETWEEN TWO VESSELS

(75) Inventor: Leon Yuan, Rockville, MD (US)

Correspondence Address: HONEYWELL/UOP;PATENT SERVICES, 101 COLUMBIA DRIVE, P O BOX 2245 MAIL STOP AB/2B, MORRISTOWN, NJ, 07962, US

(73) Assignee: UOP LLC, Morristown, NJ (US)

(21) Appl. No.: 12/565,087

(22) Filed: Sep. 23, 2009

Related U.S. Application Data
(63) Continuation-in-part of application No. 11/926,562, filed on Oct. 29, 2007.

(51) Int. Cl. B65G 53/00

(52) U.S. Cl. 414/217; 414/805

(57) ABSTRACT

An apparatus and process for transporting solid particulate matter from a lower pressure vessel to a higher pressure vessel are disclosed. The apparatus includes a flow control vessel disposed between the lower and higher pressure vessels with valves for transferring solids between the vessels.

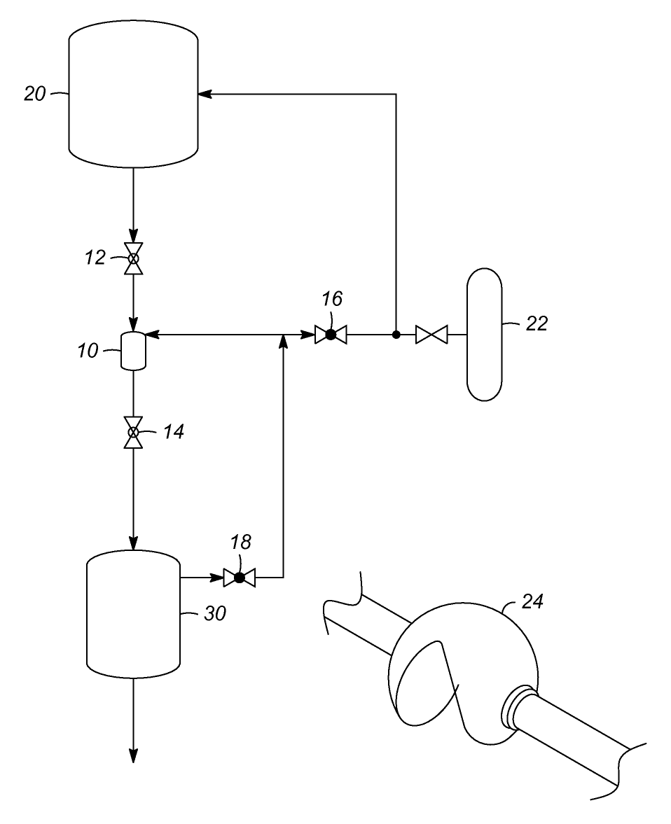

### CROSS-REFERENCE TO RELATED APPLICATION

This application is a Continuation-In-Part of copending application Ser. No. 11/926,562 filed Oct. 29, 2007, the contents of which are hereby incorporated by reference in its entirety.

### BACKGROUND OF THE INVENTION

This invention relates to the handling of solid materials, and particularly the handling of solid particulate materials where they are passed from a low pressure system to a higher pressure system. There are many processes in the petrochemical industry that use catalysts and adsorbents. The catalysts and adsorbents are frequently transferred between operational units and regeneration units, and often there is a semi-continuous flow of the catalyst and/or adsorbent through the system comprising the operational unit and the regeneration unit.

Currently, the transfer of catalyst between two vessels with reverse pressure gradient is achieved by using a valved lock hopper and flow control hopper, by valved lock hopper with a nuclear level detection instrument or by using a valveless hopper. The flow control and valved lock hopper is used to change the pressure and environment, in order to transfer the solid material from a lower pressure vessel to a higher pressure vessel. In a flow control and valved lock hopper, the flow control hopper and the valved lock hopper are separated. The flow control hopper is used to control the flow of solid particles and the valved lock hopper is used to change the pressure and environment, that is to raise the pressure for the solid particles to be transferred. In a valved lock hopper with a nuclear level detection instrument, the flow control and pressure change is combined into one gas tight valved lock hopper with nuclear level detection, the nuclear level detection is used to control the flow rate of solid by loading and unloading between the high and low level in a given time interval and the gas tight valved lock hopper changes the pressure and environment. With a valveless lock hopper, the flow control and pressure change is also combined into the lock hopper, where the hopper has three internal compartments. The pressure is cycled in the middle compartment with nuclear level detection and the solid particles are transferred from the top compartment to the middle compartment to the bottom compartment in a batchwise manner, when the pressure is equalized between the top and middle compartments and then the middle and bottom compartments. The control of the solid flow rate is achieved by batchwise solid transfer between the high and low nuclear level detection at a given time interval.

Problems exist for the first two systems which add to maintenance and the loss of catalyst through grinding that creates fines, especially in the gas tight valves where the valves are completely closed in the solid and gas lines in the dusty environment and eventually develop leaks. The valveless lock hopper loads and unloads the solid flow by changing hydraulics which is sensitive toward the design of the vessel and the solid transfer pipe between the vessel and can develop a phenomenon called “seal loss” when the reverse pressure in the solid transfer line is too high which blows empty the solid seal in the transfer pipe.

### SUMMARY OF THE INVENTION

A solution for the problem of transferring solid particles from a low pressure vessel to a high pressure vessel can improve operation and save time and money. The present invention provides for a smaller, simpler and less expensive apparatus and process for transferring solid catalyst from a low pressure vessel to a high pressure vessel and control the flow rate without the need of a nuclear level instrument. The apparatus comprises a flow control vessel having a first solid particle transfer valve disposed between the flow transfer vessel and a low pressure vessel, and a first pressure equalization valve disposed between the flow transfer vessel and the low pressure vessel to equalize pressure through a pipe connecting the flow transfer vessel to the low pressure vessel. The apparatus further includes a second solid particle transfer valve disposed between the flow control vessel and a high pressure vessel, and a second pressure equalization valve disposed between the flow transfer vessel and the high pressure vessel to equalize pressure through a pip connecting the flow transfer vessel to the high pressure vessel.

The method of transferring solid particles from the low pressure vessel to the high pressure vessel comprises controlling in sequence the closing and opening of valves that permit the flow of solid particles and the equalization of pressure between the flow control vessel and the corresponding low or high pressure vessel.

Other objects, advantages and applications of the present invention will become apparent to those skilled in the art from the following detailed description and drawing.

### BRIEF DESCRIPTION OF THE DRAWING

The FIGURE is a diagram of the apparatus and process for transferring solids from a low pressure vessel to a high pressure vessel.

### DETAILED DESCRIPTION OF THE INVENTION

There are many processes that involve the transfer of solids between vessels. While many processes allow for the transfer through fluidization, or the use of positive pressure differentials, often there are processes where the vessels containing the solids are operated at different conditions. A particular problem exists when the solids, usually in particulate form, need to be transferred from a lower pressure vessel to a higher pressure vessel. To avoid the need for extra vessels for the transfer of solids, or for large complex vessels having segregated internal chambers, it has been found that a single smaller vessel can handle the transfer.

The present invention, as illustrated in the FIGURE, comprises a flow control vessel 10, a first solid particle transfer valve 12, a second particle transfer valve 14, a first equalization valve 16 and a second equalization valve 18. The flow control vessel 10 is disposed between a low pressure vessel 20 and a high pressure vessel 30. The first solid particle transfer valve 12 is disposed between the low pressure vessel 20 and the flow control vessel 10, and the second particle transfer valve 14 is disposed between the flow control vessel 10 and the high pressure vessel 30. The first pressure equalization valve 16 is disposed between the low pressure vessel 20 and the flow control vessel 10, and the second pressure equalization valve 18 is disposed between the flow control vessel 10 and the high pressure vessel 30. The flow control vessel 10 is sized to be sufficiently smaller than the high pressure vessel 30, such that pressure fluctuations in the high pressure vessel 30 are minimized when the second pressure equalization valve 18 is opened.

The low pressure vessel 20 is in communication with the flow control vessel 10 through a conduit, and the solid particle transfer valve 12 controls the flow of particles through the conduit. The pressure between the low pressure vessel 20 and the flow control vessel 10 is controlled through the first equalization valve 16 through a pipe connecting the low pressure vessel 20 to the flow control vessel 10. The high pressure vessel 30 is in communication with the flow control vessel 10 through a second conduit, and the solid particle transfer valve 14 controls the flow of particles through the second conduit. The pressure between the high pressure vessel 30 and the flow control vessel 10 is controlled through the second equalization valve 18 through a pipe connecting the high pressure vessel 30 to the flow control vessel 10.

In the context of the present invention, the terms low pressure and high pressure are relative values and are not intended to convey absolute values. The terms refer to two vessels where solid particles are transferred from a first vessel to a second vessel and where the second vessel has a higher pressure than the first vessel. The pressure differences can be great, for example greater than 1000 psig, or relatively small, for example less than 100 psig.

The solid particle transfer valves 12, 14 are valves designed for the movement of solids and can close on the solid particles. The valves 12, 14 are not required to be gas tight, and can allow for flow of gas through the valves 12, 14 when the valves 12, 14 are closed. In one embodiment, the solid particle transfer valves 12, 14 are ball valves 24 with a vee-shaped opening, and are also known as vee-port valves. The vee-port valves 24 are ball valves with a vee-shaped notch rather than a hole through the ball.

The pressure equalization valves 16, 18 provide fluid communication between the flow control vessel 10 and the respective low and high pressure vessels 20, 30. The fluid communication is provided by appropriate piping with the valves 16, 18 able to close off flow between vessels. The pressure equalization valve 18 provide a means, via flow through a separate pipe, for passing gas from the high pressure vessel 30 to the flow control vessel 10 without passing solids until the pressure in the two vessels is substantially equal. Likewise, during the loading of solid from the low pressure vessel 20 to the flow control vessel 10, the pressure equalization valve 16 provides for flow of gas, through a separate pipe, to substantially equalize the pressure between the two vessels.

In an alternative embodiment, the pressure equalization valves 16, 18 do not provide communication between the flow control vessel 10 and the low and high pressure vessels 20, 30 respectively, but provide open to another environment for pressure equalization. One method of equalization is to use connect the flow control vessel 10 with a high pressure gas line via the high pressure equalization valve 18. Typically, this would use an inert gas, such as nitrogen, for providing an equalization of pressure between the high pressure vessel 30 and the flow control vessel 10. For equalizing the pressure between the flow control vessel 10 and the low pressure vessel 20, the low pressure equalization valve 16 can vent the gases in the flow control vessel 10 to other places in the plant where the pressure is similar to the low pressure vessel.

In another alternative embodiment, the pressure equalization valves 16, 18 can provide for fluid communication with a vapor surge vessel 22, where the vapor surge vessel provides for adding and withdrawing gas from the flow control vessel 10 to provide pressure equalization.

The advantage of the present invention is that there is only one vessel for the transfer of solid particles, and that the vessel does not need more complex internal compartments in a much larger vessel. The invention does not require gas-tight valves between the flow control vessel 10 and the low and high pressure vessels 20, 30. The one vessel for the transfer of solid particles is fully filled and emptied and no nuclear level instrument is needed. Particles are transferred over a given time interval such that the solid transfer rate is controlled by controlling the cycle time and is determined by the design volume of the flow control vessel 10. This is advantageous over the flow control-lock hopper system where there is one vessel to control the rate of flow of solids and the other lock hopper is to transfer the particles for low pressure to high pressure. This requires many valves that must be gas tight to prevent back pressure leakage. This is also advantageous over the valveless lock hopper system, as the valveless lock hopper system uses a large vessel with three internal compartments and relies on the hydraulic gradient between the compartments to prevent the catalyst transfer when the reverse pressure gradient between compartments is high. The vessel must be large because the sealing between the high pressure and low pressure compartments rely on having the system full of particles to avoid a large gas flow from the high pressure compartment to the low pressure compartment. When the reverse pressure gradient is high or the particle sealing between the two different pressure compartment is not enough, the particle seal will be blow open and the particle transfer becomes impossible. This is commonly refer to as “seal loss”. In order to maintain the particle seal, it is necessary to maintain a particle level in the middle compartment. This requires the use of nuclear level instrument to control the solid level. The current invention is advantageous that the vessel to transfer the solid particle is fully filled or empty that it does not need the expensive and environment unfriendly nuclear level instrumentation.

The present invention avoids these problems because it does not need the nuclear level instrumentation as it does in all three systems, it does not need the gas tight valves in the first and second systems, and uses valves that allow for gas leakage to reduce the seal height requirement of the third valveless system. With a smaller flow control vessel 10, the vessel volume is smaller relative to the low and high pressure environments, and the varying pressure in the flow control vessel 10 has little impact on the pressures in the low and high pressure vessels 20, 30 which makes the system less sensitive toward the action of the gas pressure equalization valve. This provides for easier control in the transfer of solids between the vessels 20, 30.

The size of the flow control vessel 10 relative to the high pressure vessel 30 is dependent on the pressure difference between the low pressure vessel 20 and the high pressure vessel 30. As such, the flow control vessel 10 is at least less than 25% of the volume of the low pressure vessel 20 or the high pressure vessel 30, and preferable less than 10% of the volume of the low pressure vessel 20 or the high pressure vessel 30, and more preferably less than 3%.

The transfer of solids from the low pressure vessel 20 to the flow control vessel 10 is generally gravity driven, therefore one embodiment has the low pressure vessel 20 at an elevation greater than the flow control vessel 10. Likewise, the transfer of solids from the flow control vessel 10 to the high pressure vessel 30 is also gravity driven and therefore the elevation for the flow control vessel 10 is greater than the high pressure vessel 30.

Other embodiments can allow for plant geography where the relative elevation of the different vessels cannot be accommodated with the low pressure vessel 20 above the flow control vessel 10 and the flow control vessel 10 above the high pressure vessel 30. When this is not possible, mechanical or hydraulic means can be used to transfer the solids within a piping system, such that the solids can be gravity fed to the flow control vessel 10 and afterwards, the solids from the flow control vessel 10 can be gravity fed to the high pressure vessel 30. One such example can be the use of a screw system within the pipe connecting the low pressure vessel 20 to the flow control vessel 10, where solids leaving the bottom of the low pressure vessel 20 are driven by the screw mechanism in the connecting pipe to an elevation above the flow control vessel 10. Another such example can be the use of pneumatic lifter for the lifting of particles directly into the flow control vessel 10.

In one embodiment, the process for using this invention comprises a system with the low pressure vessel 20 above the flow control vessel 10, and the flow control vessel 10 above the high pressure vessel 30. The process comprises closing the second solid particle transfer valve 14 and the second pressure equalization valve 18 between the high pressure vessel 30 and the flow control vessel 10. The first solid particle transfer valve 12 and the first pressure equalization valve 16 between the low pressure vessel 20 and the flow control vessel 10 are opened. Solid particles from the low pressure vessel 20 flow into the flow control vessel 10. When a predetermined amount of solid particles have passed from the low pressure vessel 20 to the flow control vessel 10, the first solid particle transfer valve 12 and the first pressure equalization valve 16 are closed. While the solid particle transfer valves 12, 14 are closed, there will still be some gas leakage, but in an amount insufficient to prevent flow of the solid, or to disrupt the pressure in the high pressure vessel 20. After closing the first solid particle transfer valve 12 and the first pressure equalization valve 16, the second pressure equalization valve 18 is opened, and the second solid particle transfer valve 14 is opened. Solid particles from the flow control vessel 10 flow into the high pressure vessel 30. When the flow control vessel 10 is emptied, the process is repeated with the closing the second solid particle transfer valve 14 and the second pressure equalization valve 18 between the high pressure vessel 30 and the flow control vessel 10.

In an alternate embodiment of the process, the process comprises closing the second solid particle transfer valve 14 between the high pressure vessel 30 and the flow control vessel 10, and the valve to the high pressure gas line. The first solid particle transfer valve 12 and the first pressure equalization valve 16 between the low pressure vessel 20 and the flow control vessel 10 are opened. Solid particles from the low pressure vessel 20 flow into the flow control vessel 10. When a predetermined time/amount of solid particles have passed from the low pressure vessel 20 to the flow control vessel 10, the first solid particle transfer valve 12 and the first pressure equalization valve 16 are closed. After closing the first solid particle transfer valve 12 and the first pressure equalization valve 16, the valve to the high pressure gas line is opened, and the second solid particle transfer valve 14 is opened. Solid particles from the flow control vessel 10 flow into the high pressure vessel 30. When the flow control vessel 10 is emptied, the process is repeated with the closing the second solid particle transfer valve 14 between the high pressure vessel 30 and the flow control vessel 10, and the closing of the valve to the high pressure gas line.

In another operational mode, the process comprises closing the second solid particle transfer valve 14 between the high pressure vessel 30 and the flow control vessel 10, and the valve to the pressurized surge vessel. The first solid particle transfer valve 12 and the first pressure equalization valve 16 between the low pressure vessel 20 and the flow control vessel 10 are opened. Solid particles from the low pressure vessel 20 flow into the flow control vessel 10. When a predetermined time/amount of solid particles have passed from the low pressure vessel 20 to the flow control vessel 10, the first solid particle transfer valve 12 and the first pressure equalization valve 16 are closed. After closing the first solid particle transfer valve 12 and the first pressure equalization valve 16, the valve to the pressurized surge vessel is opened, and the second solid particle transfer valve 14 is opened. Solid particles from the flow control vessel 10 flow into the high pressure vessel 30. When the flow control vessel 10 is emptied, the process is repeated with the closing the second solid particle transfer valve 14 between the high pressure vessel 30 and the flow control vessel 10, and the closing of the valve to the pressurized surge vessel.

While the invention has been described with what are presently considered the preferred embodiments, it is to be understood that the invention is not limited to the disclosed embodiments, but it is intended to cover various modifications and equivalent arrangements included within the scope of the appended claims.

1. An apparatus for transferring solid particulate matter from a low pressure vessel to a high pressure vessel comprising:
a flow control vessel disposed between the low pressure vessel and the high pressure vessel, wherein the low pressure vessel is in fluid communication with the flow control vessel and the flow control vessel is in fluid communication with the high pressure vessel, and where the flow control vessel is less than 25% the volume of the low pressure vessel or high pressure vessel;
a first solid particle transfer valve disposed between the low pressure vessel and the flow control vessel;
a second solid particle transfer valve disposed between the flow control vessel and the high pressure vessel;
a pressure equalization valve disposed between the low pressure vessel and the flow control vessel; and
a pressure equalization valve disposed between the flow control vessel and the high pressure vessel; wherein the first and second solid particle transfer valves are non-gas tight valves.

2. The apparatus of claim l wherein the flow control vessel is less than 10% the volume of the low pressure vessel or high pressure vessel.

3. The apparatus of claim 2 wherein the flow control vessel is less than 3% the volume of the low pressure vessel or high pressure vessel.

4. The apparatus of claim 1 wherein the first and second solid particle transfer valves are ball valves with a vee-shaped opening.

5. The apparatus of claim 1 further comprising a gas pressurization line.

6. The apparatus of claim 1 further comprising a vapor surge vessel.

7. A process for transferring solid particulate matter from a low pressure vessel to a high pressure vessel comprising:
(a) closing a second solid particle transfer valve and a second equalization valve between the high pressure vessel and a flow control vessel, wherein the second solid particle transfer valve is a non-gas tight valve;
(b) opening a first solid particle transfer valve and a first equalization valve between the low pressure vessel and the flow control vessel, wherein the first solid particle transfer valve is a non-gas tight valve;
(c) flowing the solid particulate matter from the low pressure vessel to the flow control vessel;
(d) closing the first solid particle transfer valve and the first equalization valve between the low pressure vessel and the flow control vessel;
(e) opening the second equalization valve and the second solid particle transfer valve between the high pressure vessel and a flow control vessel;
(f) flowing the solid particulate matter from the flow control vessel to the high pressure vessel; and
(g) repeat step (a).

8. The process of claim 7 further comprising opening a third valve to a pressurized gas line after step (d).

9. The process of claim 7 further comprising opening a valve to a pressurized surge vessel after step (d).
